(19) United States
(12) Patent Application Publication
(10) Pub. No.: US 2015/0280803 A1
(43) Pub. Date: Oct. 1, 2015

(54) ADAPTIVE WAITING TIME IN MULTIPLE RECEIVE DIVERSITY CONTROL FOR TD-SCDMA

(71) Applicants: Jinghu CHEN, San Diego, CA (US); Wanlun ZHAO, San Diego, CA (US); Qiang SHEN, San Diego, CA (US); Insung KANG, San Diego, CA (US); Jilei HOU, San Diego, CA (US); QUALCOMM INCORPORATED, San Diego, CA (US)

(72) Inventors: Jinghu Chen, San Diego, CA (US); Wanlun Zhao, San Diego, CA (US); Qiang Shen, San Diego, CA (US); Insung Kang, San Diego, CA (US); Jilei Hou, Beijing (CN)

(21) Appl. No.: 14/433,596

(22) PCT Filed: Jun. 18, 2013
(86) PCT No.: PCT/CN2013/077386

§ 371 Date: Apr. 3, 2015

(30) Foreign Application Priority Data
Nov. 8, 2012 (CN) PCT/CN2012/084296

(51) Int. Cl. H04B 7/08; H04W 52/02; H04L 5/00

(52) U.S. Cl. CPC H04B 7/0877; H04L 5/0048; H04W 52/0232; H04W 88/12

(57) ABSTRACT

In an aspect of the disclosure, a method, a computer program product, and an apparatus are provided. The apparatus switches from a multiple receive diversity (RxD) on state to a RxD off state upon detecting a condition is in a certain state. The condition may be a high measure of correlation between a first antenna and a second antenna, or a high level of imbalance between the first antenna and the second antenna. The apparatus also periodically switches back to the RxD on state to determine if the condition remains in the certain state. The time period between entries into the RxD on state is dynamically adjusted as a function of prior conditions.

### CROSS-REFERENCE TO RELATED APPLICATION(S)

This application claims the benefit of PCT Application Serial No. PCT/CN2012/084296, entitled “Adaptive Waiting Time in Multiple Receive Diversity Control for TD-SCDMA” and filed on Nov. 8, 2012, which is expressly incorporated by reference herein in its entirety.

### BACKGROUND

1. Field

Aspects of the present disclosure relate generally to wireless communication systems, and more particularly, to adaptive waiting time in multiple receive diversity (RxD) control for time division synchronous code division multiple access (TD-SCDMA).

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In an aspect of the disclosure, a method, a computer program product, and an apparatus are provided. The apparatus switches from a multiple receive diversity (RxD) on state to a RxD off state upon detecting a condition is in a certain state. The condition may be a high measure of correlation between a first antenna and a second antenna, or a high level of imbalance between the first antenna and the second antenna. The apparatus also periodically switches back to the RxD on state to determine if the condition remains in the certain state. The time period between entries into the RxD on state is dynamically adjusted as a function of prior conditions.

### BRIEF DESCRIPTION OF THE DRAWINGS

FIG. 1 is a block diagram illustrating a wireless communications system.

FIG. 2 is a block diagram illustrating an example of a Node B in communication with a UE in a wireless communications system.

FIG. 3 is a block diagram of a Node B and a UE.

FIG. 4 is a state diagram illustrating movement between a RxD on state and a RxD off state.

FIG. 5 are graphs illustrating a hysteresis count as a function of state machine variable time, and adaptive time periods between RxD on states and RxD off states.

FIG. 6 are graphs illustrating a filter value as a function of state machine variable time, and adaptive time periods between RxD on states and RxD off states.

FIG. 7 is a flow chart of a method of wireless communication.

FIG. 8 is a conceptual data flow diagram illustrating the data flow between different modules/means/components in an exemplary apparatus.

FIG. 9 is a diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

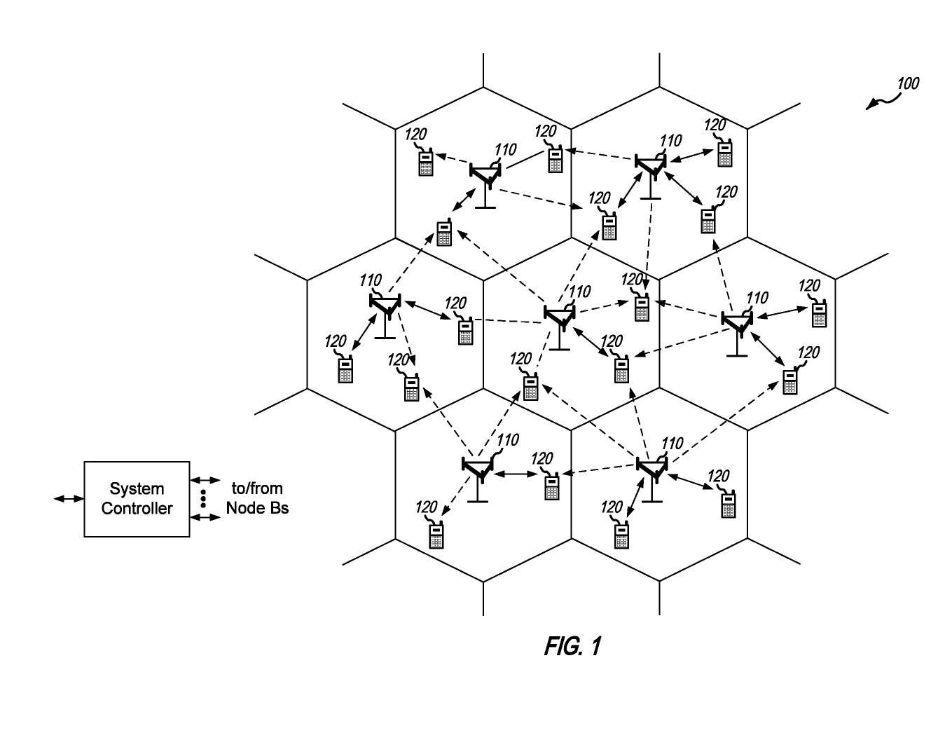

FIG. 1 shows a wireless communication system 100 with multiple Node Bs 110. A Node B is a station that communicates with the UEs and may also be referred to as a base station, an evolved Node B (eNode B), an access point, etc. Each Node B 110 provides communication coverage for a particular geographic area. The term “cell” can refer to a coverage area of a Node B and/or a Node B subsystem serving this coverage area, depending on the context in which the term is used. A Node B may serve one or multiple (e.g., three) cells.

UEs 120 may be dispersed throughout the system, and each UE may be stationary or mobile. A UE may also be referred to as a mobile station, a mobile equipment, a terminal, an access terminal, a subscriber unit, a station, etc. A UE may be a cellular phone, a personal digital assistant (PDA), a wireless communication device, a handheld device, a wireless modem, etc. A UE may communicate with a Node B via the downlink and uplink. The downlink (or forward link) refers to the communication link from the Node B to the UE, and the uplink (or reverse link) refers to the communication link from the UE to the Node B. In FIG. 1, a solid line with double arrows indicates communication between a Node B and a UE. A broken line with a single arrow indicates a UE receiving downlink signals from a Node B. A UE may perform a search based on the downlink signals transmitted by the Node Bs.

A system controller 130 may couple to the Node Bs 110 and may provide coordination and control for these Node Bs. System controller 130 may be a single network entity or a collection of network entities.

A UE may perform a search to detect cells when the UE is first powered up, when the UE loses coverage, when the UE is idle, or when the UE is in active communication. The UE may perform the search based on known signals transmitted by each cell in the system. Different systems may utilize different synchronization and pilot signals/channels to assist searching by UEs. For clarity, synchronization and pilot signals/channels used for searches in WCDMA are described below.

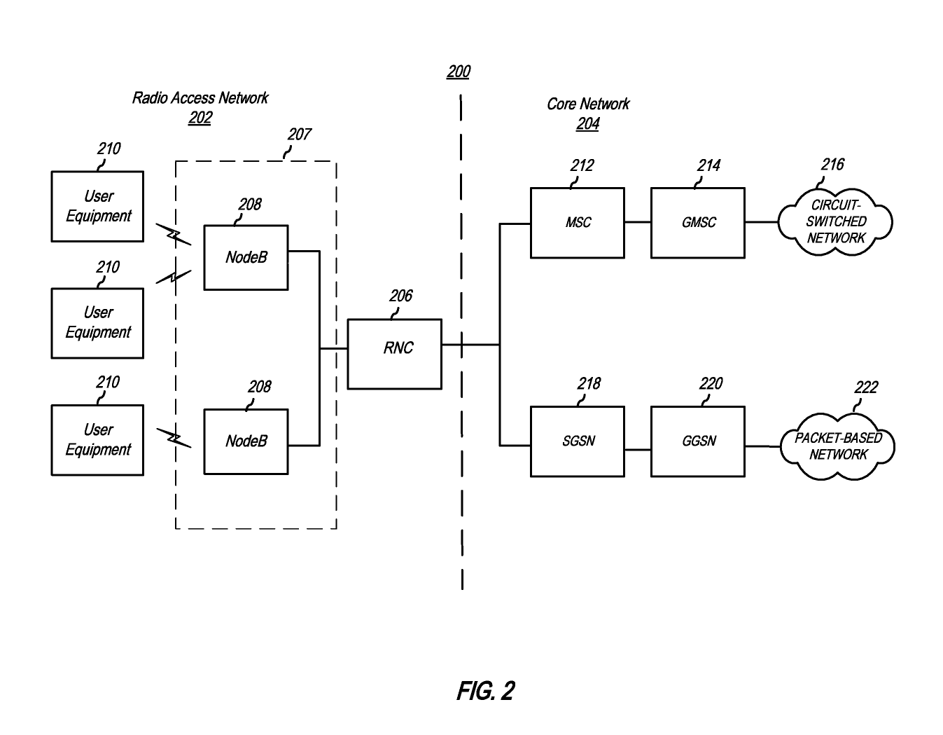

Turning now to FIG. 2, a block diagram is shown illustrating an example of a communications system 200. The various concepts presented throughout this disclosure may be implemented across a broad variety of telecommunication systems, network architectures, and communication standards. By way of example and without limitation, the aspects of the present disclosure illustrated in FIG. 2 are presented with reference to a UMTS system employing a TD-SCDMA standard. In this example, the UMTS system includes a (radio access network) RAN 202 (e.g., UTRAN) that provides various wireless services including telephony, video, data, messaging, broadcasts, and/or other services. The RAN 202 may be divided into a number of Radio Network Subsystems (RNSs) such as an RNS 207, each controlled by a Radio Network Controller (RNC) such as an RNC 206. For clarity, only the RNC 206 and the RNS 207 are shown; however, the RAN 202 may include any number of RNCs and RNSs in addition to the RNC 206 and RNS 207. The RNC 206 is an apparatus responsible for, among other things, assigning, reconfiguring and releasing radio resources within the RNS 207. The RNC 206 may be interconnected to other RNCs (not shown) in the RAN 202 through various types of interfaces such as a direct physical connection, a virtual network, or the like, using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 208 are shown; however, the RNS 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 210 are shown in communication with the Node Bs 208. The downlink (DL), also called the forward link, refers to the communication link from a Node B to a UE, and the uplink (UL), also called the reverse link, refers to the communication link from a UE to a Node B.

The core network 204, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 204 supports circuit-switched services with a mobile switching center (MSC) 212 and a gateway MSC (GMSC) 214. One or more RNCs, such as the RNC 206, may be connected to the MSC 212. The MSC 212 is an apparatus that controls call setup, call routing, and UE mobility functions. The MSC 212 also includes a visitor location register (VLR) (not shown) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard GSM circuit-switched data services. The GGSN 220 provides a connection for the RAN 202 to a packet-based network 222. The packet-based network 222 may be the Internet, a private data network, or some other suitable packet-based network. The primary function of the GGSN 220 is to provide the UEs 210 with packet-based network connectivity. Data packets are transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 208 and a UE 210, but divides uplink and downlink transmissions into different time slots in the carrier.

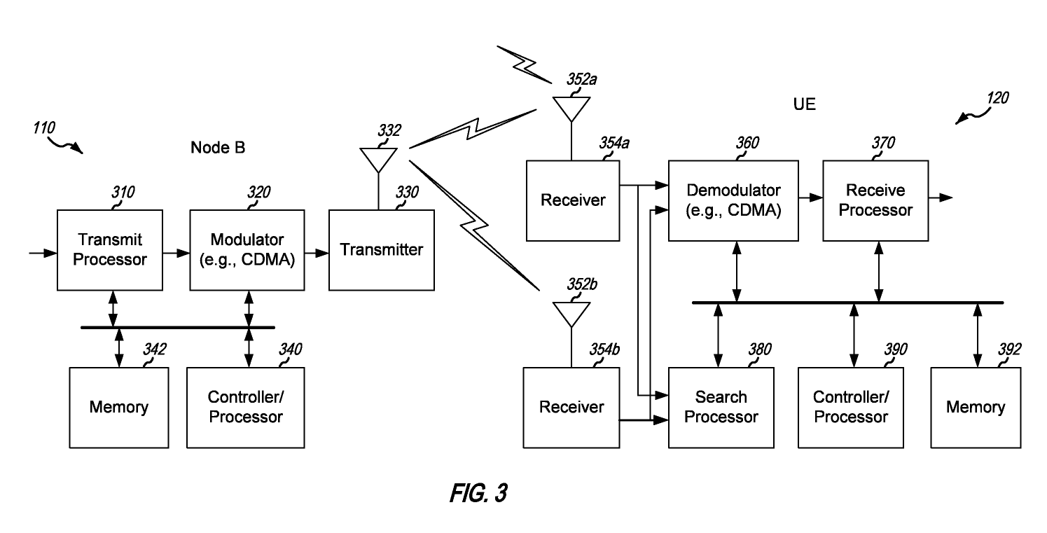

FIG. 3 shows a block diagram of an exemplary design of a Node B 110 and a UE 120, which may be one of the Node Bs and one of the UEs in FIG. 1 or FIG. 2. In the exemplary design shown in FIG. 3, Node B 110 is equipped with a single transmit antenna 332, and LIE 120 is equipped with two receive antennas 352a and 352b, which may be referred to as antennas 1 and 2, respectively. In general, Node B 110 and UE 120 may each be equipped with any number of antennas.

At Node B 110, a transmit processor 310 may receive traffic data for UEs being served and may process (e.g., encode, interleave, and symbol map) the traffic data to generate data symbols. Processor 310 may also generate overhead symbols for the primary SCH, the secondary SCH, and other overhead channels. Processor 310 may also generate pilot symbols for the CPICH. A modulator 320 may process the data symbols, the overhead symbols, and the pilot symbols (e.g., for CDMA) and may provide output samples to a transmitter 330. Modulator 320 may spread the symbols for each physical channel (except for SCH) with a channelization code for that channel, apply the scrambling code for a cell, scale the samples for each physical channel with a gain determined by the transmit power for that channel, and sum the scaled samples for these physical channels with the samples for the P-SCH and S-SCH, which have been scaled with gains determined by the transmit power for the P-SCH and S-SCH, to obtain the output samples. Transmitter 330 may process (e.g., convert to analog, amplify, filter, and frequency upconvert) the output samples and generate a downlink signal, which may be transmitted via antenna 332.

At UE 120, antennas 352a and 352b may receive the downlink signals from Node B 110 and other Node Bs. Each antenna 352 may provide a received signal to an associated receiver 354. Each receiver 354 may process (e.g., filter, amplify, frequency downconvert, and digitize) its received signal and may provide input samples to a demodulator 360 and a search processor 380. Search processor 380 may perform searches to detect cells and may provide search results for detected cells, as described below. Demodulator 360 may process the input samples in a manner complementary to the processing by modulator 320 and may provide symbol estimates, which may be estimates of the symbols transmitted by Node B 110. Demodulator 360 may implement a rake receiver that can process multiple signal instances in the received signal from each antenna 352 due to multiple signal paths between Node B 110 and that antenna. A receive processor 370 may process (e.g., symbol demap, deinterleave, and decode) the symbol estimates and may provide decoded data and signaling. In general, the processing by demodulator 360 and receive processor 370 at UE 120 may be complementary to the processing by modulator 320 and transmit processor 310, respectively, at Node B 110.

Controllers/processors 340 and 390 may direct the operation at Node B 110 and UE 120, respectively. Memories 342 and 392 may store data and program codes for Node B 110 and UE 120, respectively.

The UE may be equipped with multiple receive antennas that may be used to receive signals from cells. Receive diversity (RxD) may be achieved by receiving a signal from a given cell via one or a combination of the multiple receive antennas. Receive diversity may improve performance. RxD, however, increases power consumption. The controller/processor 390 of the UE 120 includes a RxD controller that, as described further below, operates to 1) place the UE in an RxD_On state during which the multiple receive antennas of the UE receive signals, 2) to decide whether other operating conditions of the UE warrant switching the UE to an RxD_Off state, and 3) to periodically determine whether the other operating condition of the UE warrants returning to the RxD_On state.

In dynamic RxD control in TD-SCDMA, when the UE is in an Idle mode or a Tracking mode, the RxD controller decides whether to turn on RxD based on metrics such as antenna signal-to-interference ratio (SIR), SIR_Target and short-term block error rate (BLER). When the UE is in RxD_On state, the RxD controller may also check some conditions to see if it is worthwhile to keep RxD on. Those conditions include the correlation and imbalance between the Rx antennas. For example, when the two antennas are highly correlated or highly imbalanced, then there is no benefit in keeping the two antennas on. Accordingly, one of the two antennas may be turned off to save power, even though some other performance metrics may suggest maintaining the RxD on state. After the UE enters into RxD_Off state, it should wait for a certain period of time and then go back to RxD_On state to check whether the conditions that prevent RxD from being turned on still hold or not. In conventional systems, this period of time is a fixed constant time. In contrast, according to the present apparatus and methods, the RxD controller component of the controller/processor 390 is configured to dynamically adjust the time period for the UE to wait to go back to the RxD_On state. In an aspect, the time period may be dynamically adjusted as a function of previously determined conditions, wherein the previously determined conditions may include, but are not limited to, one or more of a high measure of correlation between a first antenna and a second antenna, or a high level of imbalance between the first antenna and the second antenna.

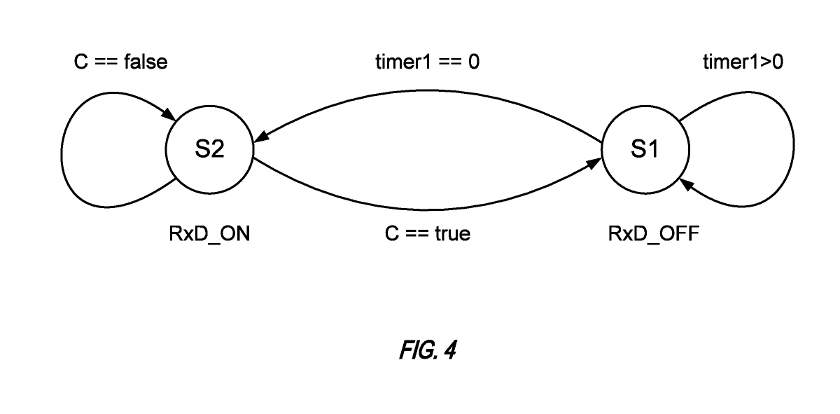

FIG. 4 is a state diagram illustrating movement of a UE between RxD_Off state and RxD_On state according to the present apparatus and methods. This state diagram operation is implementable by the RxD controller component of the controller/processor 390 (FIG. 3), which may be configured to operate a state machine representing this state diagram.

1) In these aspects, there are two states, state S1 (e.g., RxD_Off) and state S2 (e.g., RxD_On), and the state machine is updated periodically, where the time period (“ΔT”) between updates is maintained by a clock (“time1”).

2) State S2 may be the preferred state in which to remain given a set of performance metrics. However, if a condition C is in a certain state, e.g., true, the state machine is transferred from state S2 to state S1. As noted above, the condition may be one or more of high correlation between the receive antennas and high imbalance between the receive antennas.

3) The condition C may be measured in state S2, and it takes at least N×ΔT time to perform the measure.

4) Upon going into the state S1, the state machine waits for a period of time specified by timer1, and then goes back to state S2 to check whether condition C is true.

Conventionally, whenever the state machine goes into state S1, the state machine waits for a set period of time before going back to state S2 again to check whether C is true. Adaptively adjusting the time period maintained by timer 1 between condition checks may be beneficial. For example, when the condition C==true for the first time, the change or variation in condition C that brought about the condition C==true may be the result of a short-term variation in the condition C. Therefore, it may be desirable to stay in state S1 for a relatively short period of time, and then go back from state S1 to state S2 to check whether the condition C is still true. On the other hand, if the condition check on C keeps returning C==true, then the period of time to remain in state S1, before again switching to state S2 for another condition C check, may gradually increase. The gradual increase in the time period may continue until the time period reaches a maximum time period.

In an aspect, a method executable by the RxD controller component of the controller/processor 390 (FIG. 3) to achieve the adaptive control of timerl based on the sequence of the condition C follows:

A) First, a hysteresis counter, hyst_cnt, is defined and initialized to a minimum constant value, MIN_HYST_CNT.

B) For every time interval ΔT (corresponding to a time period between state machine status updates), no matter which state S1 (RxD_Off) or state S2 (RxD_On) the UE is in, the hyst_cnt is updated by decreasing the counter by one as follows:

hyst_cnt=max(hyst_cnt-1, MIN_HYST_CNT) (1)

where the count is set to the greater of hyst_cnt minus 1, and MIN_HYST_CNT.

C) If the UE is in state S2 (RxD_On), and the condition C is true, the counter, hyst_cnt, is updated by multiplying the counter by a factor α as follows:

hyst_cnt=min(α·hyst_cnt, MAX_HYST_CNT) (2)

where the count is set to the smaller of α·hyst_cnt and MAX_HYST_CNT, where a is related to the response speed of the UE to true conditions and is a value greater than 1. In this case, the counter is increased when the condition C is true.

Then the value of timer1, i.e., the period of time to stay in the RxD_Off state, is derived by multiplying the counter by a factor β:

timer1=β·hyst_cnt (3)

where β is a value less than the value of the counter so that the value of the timer is not equal to the value of the counter so as to prevent the timer from immediately jumping down to zero or the minimum value and to thereby retain some memory of past condition C states within the value of the timer. β is determined experimentally or based on historical data.

D) If the UE is in state S1 (RxD_Off), for every time interval ΔT of the state machine update, the time period for switching back to RxD_On to check the condition C is updated by decreasing the timer by one, as follows:

timer1=max(timer1 −1, 0) (4)

where the timer1 is set to the greater of timerl minus 1, and zero.

When the timer expires, i.e., timer1==0, the RxD controller transfers the UE to state S2.

In an aspect, an advantage of the proposed method may be that the waiting time in state S1 can be adaptively adjusted according to the frequency of C==true in recent condition checks. When C==true for the first time in a fairly long time, timer1=α·βMIN_HYST_CNT, and the time to stay in state S1 will not be too long. When C==true is occurring more frequently, timer1 becomes larger. As a result, the UE stays in state S1 for a longer period of time. Eventually, hyst_cnt can be saturated to MAX_HYST_CNT, and in that case, the time period in state S2 will be β·MAX_HYST_CNT (ΔT).

In Eq. (2), α is related to the UE's responding speed to C==true. Alternatively, the term α·hyst_cnt in Eq. (2) can be replaced by ((α·hyst_cnt)+A) in which α can be set to 1, where “A” is a value selected so as to keep the counter increasing.

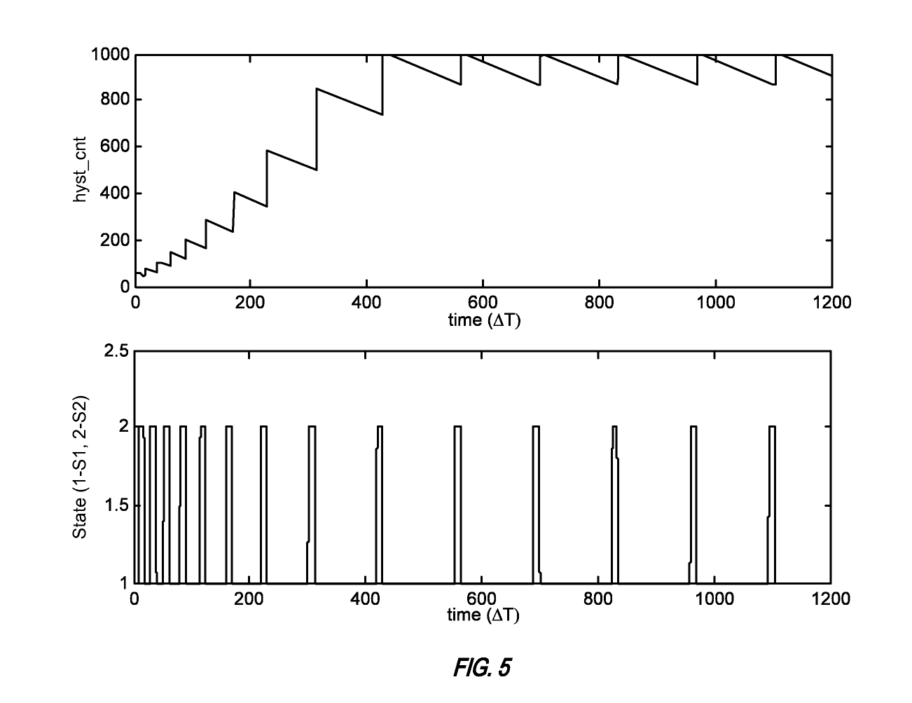

With reference to FIG. 5, to illustrate the behavior of the above method, a simulation was run with the following assumptions.

α=1.7, β=1/8;

MIN_HYST_CNT=40, MAX_HYST_CNT=1000;

Assume in RD_ON state, the condition C always returns ‘true’ after a time period of 10ΔT.

The top graph of FIG. 5 illustrates a hyst_cnt as a function of time (ΔT), where ΔT corresponds to a time between state machine updates and the condition C is always true. The counter hyst_cnt becomes increasingly larger from the beginning due to the operation of step C) above. The intermittent downward trend in hyst_cnt is due to the operation of step B) above, where the count is decremented, no matter what the state S1 or state S2 is, for every time interval ΔT. If the condition C eventually becomes consistently false, for example, after the count reaches its maximum of 1000, then the hyst_cnt would gradually decrease toward the minimum count of 40.

The bottom graph of FIG. 5 illustrates changing time periods for remaining in state S1, where a time period corresponds to the amount of time between adjacent vertical bars. From this graph, it is noted that the time periods become longer until the time period saturates to a constant. In comparing the top and bottom graphs, the time period is shown to dynamically increase as the hyst_cnt increases. When the hyst_cnt reaches it maximum and remains there the time periods correspondingly reach a constant value.

Another method to achieve adaptive control of timerl based on the sequence of the condition C follows:

W) First, a time stamp (“t_s”) is defined. The time stamp stores the time of the previous update of condition C.

X) For every valid check of condition C (regardless of whether C==true or C==false), a current time stamp (“t_curr”) is denoted.

Y) If (t_curr−t_s)<Th_time, a infinite impulse response (IIR) filter is update with:

F(n)=γ·x+(1−γ)·F(n−1)

where x=0 or 1 for C=false or true, respectively, and Th_time is a threshold.

If t_curr−t_s>=Th_time, the IIR filter is reset to:

F(n)=γ·x.

In addition, the time stamp t_s is update with the current time, i.e., t_s=t_curr.

Z) If C==true, timer1 is derived as follows:

timer1=F(n)·MAX_TIMER1

If timer1<MIN_TIMER1, then timer1 is set equal to MIN_TIMER1. MIN_TIMER1 and MAX_TIMER1 are two constants that specify the minimum and maximum value of timer1, respectively.

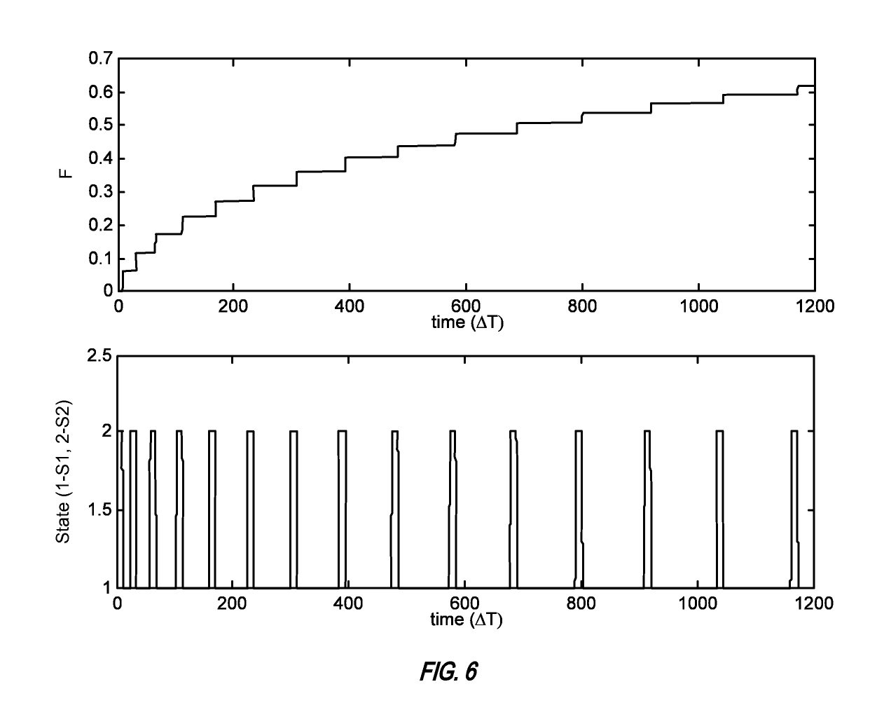

With reference to FIG. 6, to illustrate the behavior of the above method, a simulation was run with the following assumptions.

γ=1/16;

MAX_TIMER1=200, MIN_TIMER1=10;

Assume in RD_ON state, the condition C always returns ‘true’ after a time period of 10ΔT.

The top graph of FIG. 6 illustrates a filter value (F) as a function of time (ΔT), where ΔT corresponds to a time between state machine updates and the condition C is always true. The filter value becomes increasingly larger from time zero due to the operation of step Y) above.

The bottom graph illustrates changing time periods for remaining in state S1, where a time period corresponds to the amount of time between adjacent vertical bars. From this graph, it is noted that the time periods become increasingly longer until saturated to a constant. In comparing the top and bottom graphs, the time period is shown to dynamically increase as the filter value increases. When the filter value reaches it maximum and remains there the time periods correspondingly reach a constant value.

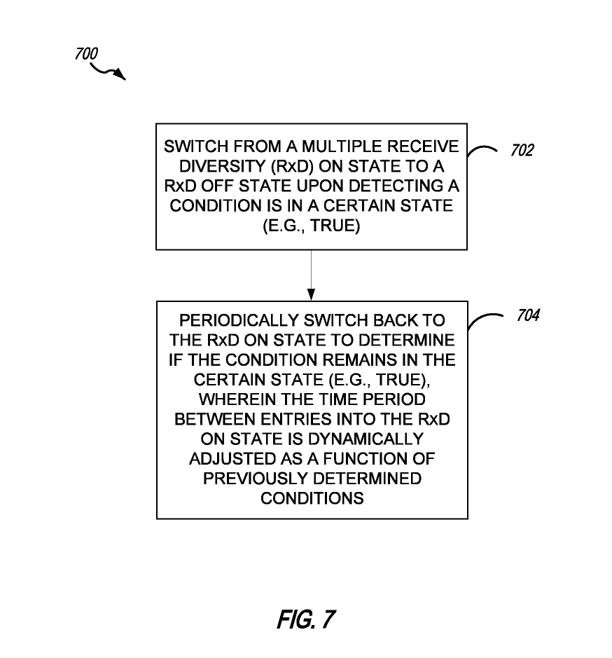

FIG. 7 is a flow chart 700 of a method of wireless communication. The method may be performed by a UE or a component thereof, such as but not limited to the RxD controller component of the controller/processor 390 (FIG. 3). At step 702, the UE switches from a RxD on state to a RxD off state upon detecting a condition is in a certain state. The state may be a true state or a false state. A true state of the condition may, for example, correspond to a high measure of correlation between a first antenna and a second antenna, or a high level of imbalance between the first antenna and the second antenna.

At step 704, the UE periodically switches back to the RxD on state to determine if the condition remains in the certain state. The time period between entries into the RxD on state is dynamically adjusted as a function of previously determined conditions. The dynamic adjustment may involve steps A through D, or steps W through X, as previously described. In one configuration, the function of prior conditions comprises a count of prior conditions in the certain state, and the time period changes as a function of a changing count of prior conditions which are in the certain state.

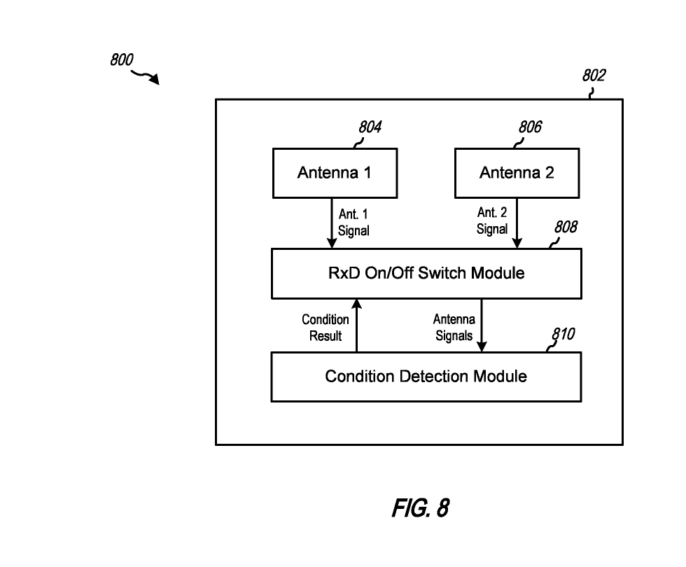

FIG. 8 is a conceptual data flow diagram 800 illustrating the data flow between different modules/means/components in an exemplary apparatus 802. The apparatus may be a UE, and the different modules/means/components may be included in, for example, the RxD controller component of the controller/processor 390 (FIG. 3).

In an aspect, the apparatus 802 includes a first antenna 804, a second antenna 806, a RxD on/off switch module 808, and a condition detection module 810. The RxD on/off switch module 808 switches the UE 802 from a RxD on state, during which the first antenna 804 and second antenna 806 receive signals, to a RxD off state, during which only one of the antennas 804, 806 receives signals. The condition detection module 810 determines the state of the condition when the UE is in an RxD on state. The condition may be based on antenna signals received from the first and second antennas 804, 806 and the condition state may be true or false. For example, a true condition may correspond to a high measure of correlation between the first antenna 804 and the second antenna 806, or a high level of imbalance between the first antenna and the second antenna.

The condition detection module 810 outputs the condition result to the RxD on/off switch module 808. Depending on the condition state, the RxD on/off switch module 808 determines whether the UE will be in an RxD off state or an RxD on state. For example, if the condition is true the RxD on/off switch module 808 may switch the UE back to the RxD off state; if the condition is false, the RxD on/off switch module 808 may maintain the UE in the RxD on state. While in the RxD off state, the RxD on/off switch module 808 periodically switches the UE back to the RxD on state to determine if the condition remains true. As described above, the RxD on/off switch module 808 dynamically adjusts the time period between entries into the RxD on state as a function of prior condition states.

The apparatus 802 may include additional modules that perform each of the steps of the algorithm in the aforementioned flow chart of FIG. 7, steps A through D of the algorithm described above, and steps W through Z of the algorithm described above. As such, each step in the aforementioned flow charts of FIG. 7, steps A through D and steps W through Z may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

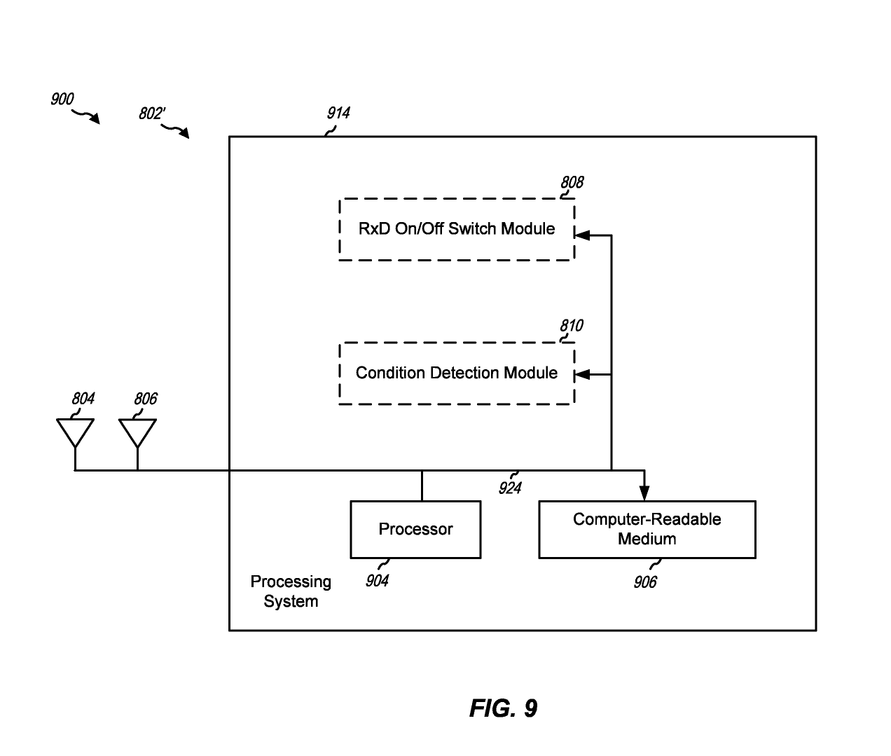

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware modules, represented by the processor 904, the RxD on/off switch module 808, the condition detection module 810 , and the computer-readable medium 906. The bus 924 may also link various other circuits such as timing sources, peripherals, voltage regulators, and power management circuits, which are well known in the art, and therefore, will not be described any further.

The processing system 914 includes a processor 904 coupled to a computer-readable medium 906. The processor 904 is responsible for general processing, including the execution of software stored on the computer-readable medium 906. The software, when executed by the processor 904, causes the processing system 914 to perform the various functions described supra for any particular apparatus. The computer-readable medium 906 may also be used for storing data that is manipulated by the processor 904 when executing software. The processing system further includes at least one of the RxD on/off switch module 808, the condition detection module 810. The modules may be software modules running in the processor 904, resident/stored in the computer readable medium 906, one or more hardware modules coupled to the processor 904, or some combination thereof. The processing system 914 may be a component of the UE 120 and may include the memory 392, the RX processor 370, and the controller/processor 390.

In one configuration, the apparatus 802/802′ for wireless communication includes means for switching from a RxD on state to a RxD off state upon detecting a condition is true, and means for periodically switching back to the RxD on state to determine if the condition remains true, wherein the time period between entries into the RxD on state is dynamically adjusted as a function of prior conditions. The apparatus 802/802′ also includes means for performing each of steps A through D described above and means for performing each of steps W through Z.

The aforementioned means may be one or more of the aforementioned modules of the apparatus 802 and/or the processing system 914 of the apparatus 802′ configured to perform the functions recited by the aforementioned means. As described supra, the processing system 914 may include the controller/processor 390. As such, in one configuration, the aforementioned means may be the controller/processor 390 configured to perform the functions recited by the aforementioned means.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
switching from a multiple receive diversity (RxD) on state to a RxD off state upon detecting a condition is in a certain state; and
periodically switching back to the RxD on state to determine if the condition remains in the certain state , wherein a time period between entries into the RxD on state is dynamically adjusted as a function of previously determined conditions.

2. The method of claim 1, wherein the condition comprises one or more of a high measure of correlation between a first antenna and a second antenna, or a high level of imbalance between the first antenna and the second antenna.

3. The method of claim 1, wherein the certain state is either one of a true state or a false state.

4. The method of claim 1, wherein the function of the previously determined conditions comprises a count of prior conditions in the certain state.

5. The method of claim 4, wherein the time period changes as a function of a changing count of prior conditions in the certain state.

6. The method of claim 4, wherein the count of prior conditions in the certain state has a minimum preset value and a maximum preset value.

7. An apparatus for wireless communication, comprising:
means for switching from a multiple receive diversity (RxD) on state to a RxD off state upon detecting a condition is in a certain state; and
means for periodically switching back to the RxD on state to determine if the condition remains in the certain state, wherein the time period between entries into the RxD on state is dynamically adjusted as a function of prior conditions.

8. The apparatus of claim 7, wherein the condition comprises one or more of a high measure of correlation between a first antenna and a second antenna, or a high level of imbalance between the first antenna and the second antenna.

9. The apparatus of claim 7, wherein the certain state is either one of a true state or a false state.

10. The apparatus of claim 7, wherein the function of the previously determined conditions comprises a count of prior conditions in the certain state.

11. The apparatus of claim 10, wherein the time period changes as a function of a changing count of prior conditions in the certain state.

12. The apparatus of claim 10, wherein the count of prior conditions in the certain state has a minimum preset value and a maximum preset value.

13. An apparatus for wireless communication, comprising:
at least one processor; and
a memory coupled to the at least one processor,
wherein the at least one processor is configured to:
switch from a multiple receive diversity (RxD) on state to a RxD off state upon detecting a condition is in a certain state; and
periodically switch back to the RxD on state to determine if the condition remains in the certain state, wherein the time period between entries into the RxD on state is dynamically adjusted as a function of prior conditions

14. The apparatus of claim 13, wherein the condition comprises one or more of a high measure of correlation between a first antenna and a second antenna, or a high level of imbalance between the first antenna and the second antenna.

15. The apparatus of claim 13, wherein the certain state is either one of a true state or a false state.

16. The apparatus of claim 13, wherein the function of the previously determined conditions comprises a count of prior conditions in the certain state.

17. The apparatus of claim 16, wherein the time period changes as a function of a changing count of prior conditions in the certain state.

18. The apparatus of claim 16, wherein the count of prior conditions in the certain state has a minimum preset value and a maximum preset value.

19. A computer program product, comprising:
a computer-readable medium comprising code for:
switching from a multiple receive diversity (RxD) on state to a RxD off state upon detecting a condition is in a certain state; and
periodically switching back to the RxD on state to determine if the condition remains in the certain state, wherein the time period between entries into the RxD on state is dynamically adjusted as a function of prior conditions.

20. The product of claim 19, wherein the condition comprises one or more of a high measure of correlation between a first antenna and a second antenna, or a high level of imbalance between the first antenna and the second antenna.

21. The product of claim 19, wherein the certain state is either one of a true state or a false state.

22. The product of claim 19, wherein the function of the previously determined conditions comprises a count of prior conditions in the certain state.

23. The product of claim 22, wherein the time period changes as a function of a changing count of prior conditions in the certain state.

24. The product of claim 22, wherein the count of prior conditions in the certain state has a minimum preset value and a maximum preset value.
